(19) United States
(12) Patent Application Publication
(10) Pub. No.: US 2003/0097519 A1
(43) Pub. Date: May 22, 2003

(54) Memory subsystem

(76) Inventor: Ha Ryong Yoon, Kyoungki-do (KR)

Correspondence Address: PILLSBURY WINTHROP, LLP, P.O. BOX 10500, MCLEAN, VA, 22102, US

(21) Appl. No.: 10/293,366

(22) Filed: Nov. 14, 2002

(30) Foreign Application Priority Data
Nov. 21, 2001 (KR) 2001-72776
Jul. 20, 2002 (KR) 2002-42770

(51) Int. Cl. G06F 12/00

(52) U.S. Cl. 711/5; 711/105; 711/205

(57) ABSTRACT

The present invention generally relates to a memory device. More particularly, the present invention relates to a memory system for receiving chip selecting signals and a plurality of control signals from a memory controller. The memory system comprises: a chip selecting determiner for deciding whether the chip selecting signals are enabled; a main operation command table for defining a predetermined operation corresponding to combination of the control signals when the chip selecting signals are enabled; a preliminary operation command table for defining a predetermined operation corresponding to combination of the control signals when the chip selecting signals are disabled; and a logic circuit unit for decoding the combination of the control signals into a predetermined operation, based on the main operation command table or the preliminary operation command table according to enable conditions of the chip selecting signals from the chip selecting determiner. Accordingly, bandwidths of a control bus are improved, and command tracking of a memory controller is also simplified, thereby simplifying the design of a memory controller.

### BACKGROUND OF THE INVENTION

1. Field of the Invention

The present invention relates to a technique of controlling a memory device controlled by a memory controller.

2. Description of the Prior Art

In a conventional memory subsystem comprising a plurality of memory devices such as general Asynchronous DRAM, Synchronous DRAM and Double Data Rate Synchronous DRAM, referring to FIG. 1, when a memory controller and a memory device communicates each other, a memory device having an enabled chip selecting signal recognizes a control signal received from the memory controller as its control and performs an operation corresponding to the control signal while other memory devices having disabled chip selecting signals ignore the control signal.

Referring to FIG. 1, the conventional memory subsystem comprises a memory controller 10 and a plurality of memory devices 20, 30, 40. The memory controller 10 outputs each chip selecting signals CS1, CS2, . . . , CSN and common control signals COMMAND into the memory devices 20, 30, 40. The memory controller 10 enables chip selecting signals CS1, CS2, . . . , CSN corresponding to one of the plurality of memory devices such as a first memory device 20, a second memory device 30, . . . , a N^{th} memory device 40. For example, when the first memory device 20 is selected, it decodes the combination of control signals COMMAND received from the memory controller 10 and then performs a predetermined operation. Here, the memory devices 30 and 40 receive the same control signal COMMAND that the first memory device 20 receives, but do not perform any operation because they ignore the control signals COMMAND due to disabled the chip selecting signals CS2, . . . , CSN.

However, the memory devices 30 and 40 having disabled chip selecting signals CS2, . . . , CSN do not perform any operation although they can perform internal operations having no effect on other devices such as write back (writing data from data buffer into cell), bank precharge and refresh. As a result, next operation is limited and time is wasted.

### SUMMARY OF THE INVENTION

Accordingly, the present invention has an object to provide a memory control technique wherein a memory device having disabled chip selecting signals can perform an operation having no effect on other devices while a memory device having enabled chip selecting signals performs a predetermined operation.

In order to accomplish the above-described object, there is provided a memory device for receiving chip selecting signals and a plurality of control signals from a memory controller, comprising: a chip selecting determiner for deciding whether the chip selecting signals; a main operation command table for defining a predetermined operation corresponding to combination of the control signals when the chip selecting signals are enabled; a preliminary operation command table for defining a predetermined operation corresponding to combination of the control signals when the chip selecting signals are disabled; and a logic circuit unit for decoding the combination of the control signals into a predetermined operation, based on the main operation command table or the preliminary operation command table according to enable conditions of the chip selecting signals from the chip selecting determiner.

In the memory device according to the present invention, the predetermined operation defined by the preliminary operation command table has no effect on other devices forming a memory subsystem to the memory device belongs.

There is also provided a memory subsystem comprising a plurality of memory devices for receiving a plurality of common control signals from a memory controller and the memory controller and each chip selecting signal, wherein the memory device comprises a chip selecting determiner for deciding whether the chip selecting signal is selected; a main operation command table for defining a predetermined operation corresponding to combination of the control signals for memory device having enabled chip selecting signals; a preliminary operation command table for defining a predetermined operation corresponding to combination of the control signals for memory device having disabled chip selecting signals; and a logic circuit unit for decoding the combination of the control signals into a predetermined operation, based on the main operation command table or the preliminary operation command table according to enable conditions of the chip selecting signals from the chip selecting determiner; and wherein the memory device having the enabled chip selecting signals applies the main operation command table while the memory device having disabled chip selecting signals applies the preliminary operation command table, decodes the combination of the control signals, and then performs a relevant operation.

In the memory subsystem according to the present invention, the predetermined operation defined by the preliminary operation command table has no effect on other devices forming the memory subsystem to which the memory device belongs.

There is also provided a method of controlling a memory device for receiving chip selecting signals and a plurality of control signals from a memory controller, comprising: the first step wherein the memory device determines whether the chip selecting signals are applied; the second step wherein when the chip selecting signal is enabled as a determination result of the first step, the logic circuit unit of the memory device decodes combination of the control signals applied to the memory device by using a main operation command table; the third step wherein the memory device performs a relevant operation according to a decoding result of the second step and then returns to the first step; the fourth step wherein when the chip selecting signal is disabled as a determination result of the first step, the logic circuit unit of the memory device decodes combination of the control signals applied to the memory device by using a preliminary operation command table; and the fifth step wherein the memory device performs a relevant operation according to a decoding result of the fourth step and then returns to the first step.

In the method according to the present invention, the predetermined operation defined by the preliminary operation command table has no effect on other devices forming a memory subsystem to which the memory device belongs.

### BRIEF DESCRIPTION OF THE DRAWINGS

FIG. 1 is a diagram of a conventional memory subsystem.

FIG. 2 is a diagram of a memory device in accordance with a preferred embodiment of the present invention.

FIG. 3 is a flow chart of a memory control method according to the present invention.

FIG. 4a illustrates a main operation command table in accordance with a preferred embodiment of the present invention.

FIG. 4b illustrates a preliminary operation command table in accordance with a preferred embodiment of the present invention.

FIG. 5 is a diagram of a logic circuit unit in accordance with a preferred embodiment of the present invention.

FIG. 6 is a diagram of a logic circuit unit in accordance with a preferred embodiment of the present invention.

FIG. 7 is a diagram of a logic circuit unit in accordance with a preferred embodiment of the present invention.

FIG. 8a is a command table when a conventional memory device has chip selecting signals.

FIG. 8b is a command table when a conventional memory device has no chip selecting signals.

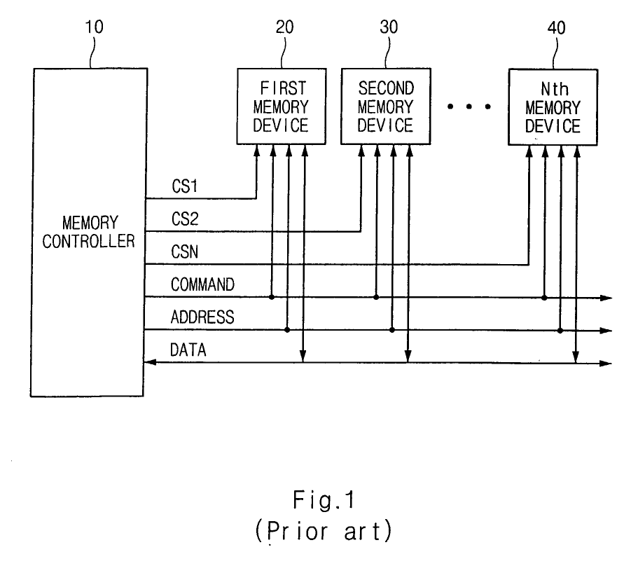

### DETAILED DESCRIPTION OF THE PREFERRED EMBODIMENTS

The present invention will be explained in terms of exemplary embodiments described in detail with reference to the accompanying drawings, which are given only by way of illustration and thus are not limitative of the present invention.

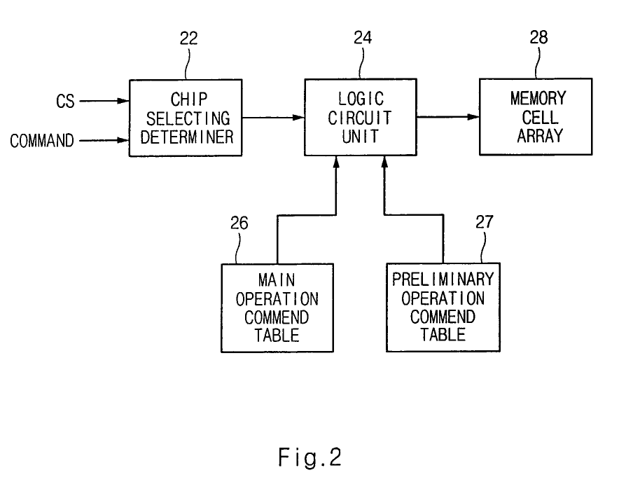

FIG. 2 is a diagram of a memory device 20 in accordance with a preferred embodiment of the present invention.

The memory device 20 comprises a chip selecting determiner 22, a logic circuit unit 24 including a main operation command table 26 and a preliminary operation command table 27, and a memory cell array 28.

The chip selecting determiner 22 determines whether a chip selecting signal CS of the relevant memory device is enabled. In the logic circuit unit 24, the main operation command table 26 is applied when the chip selecting signal CS is enabled while the preliminary operation command table 27 is applied when the chip selecting signal CS is disabled. The chip selecting determiner 22 and the logic circuit unit 24 functionally divided for explanation can be a decoding block.

The memory device 20 of the present invention is operated as follows. When the chip selecting signal CS of the first memory device 20 is enabled, the logic circuit unit 24 decodes control signals COMMAND according to the main operation command table 26. As a result, the memory device performs an operation corresponding to combination of control signals COMMAND. The main operation command table 26 is similar to a command table of the conventional because it defines the operation when the chip selecting signal CS is enabled.

Here, the logic circuits 24 of the memory devices 30 and 40 having disabled chip selecting signals CS decodes control signals COMMAND according to the preliminary operation command table 27. Then, the memory device 20 performs an operation corresponding to the COMMAND. The COMMANDs inputted in the memory devices 30 and 40 having disabled CSs are identical with the COMMANDs corresponding to a predetermined operation of the main operation command table 26 inputted in the other memory device 20 having enabled CSs. In a conventional memory system, a memory device having disabled CSs ignores these COMMANDs and does not perform any operation. However, a memory device or a memory subsystem according to the present invention performs a predetermined internal operation, comprising the extra preliminary operation command table 27 corresponding to these COMMANDs.

The operation defined by the preliminary command table 27 has no effect on other devices of the memory subsystem. The operations includes write back (writing data from data buffer into cell), bank precharge and refresh.

When the memory device 20 performs write operation, it does not write directly inputted data in a memory cell 28. After storing the data in a data buffer, the memory device 20 writes the data from the data buffer into the cell according to a subsequent command. This preferred embodiment is explained now. The conventional memory device stores temporarily data in a data buffer and then writes the data in a cell by a subsequent control signal of the memory device. While commands are performed into other memory devices 30 and 40, the memory device 20 can write data in the cell 28. However, the memory device 20 does not perform any operation although it can write data. The memory device 20 waits for COMMANDs inputted therein when its chip selecting signal is enabled. The memory controller 10 should remember which buffer of the memory device 20 stores data. However, the memory device or the memory subsystem of the present invention can write data of a data buffer in a cell 28 during the control of other memory device.

More desirably, the memory controller 10 allocates a timing slot to control not a memory device but a plurality of memory devices. As a result, the memory controller 10 can control simultaneously operations of the memory devices 20, 30 and 40. The memory device performs an operation without waiting for its chip selecting signals if there is no problem when performing the same operation simultaneously.

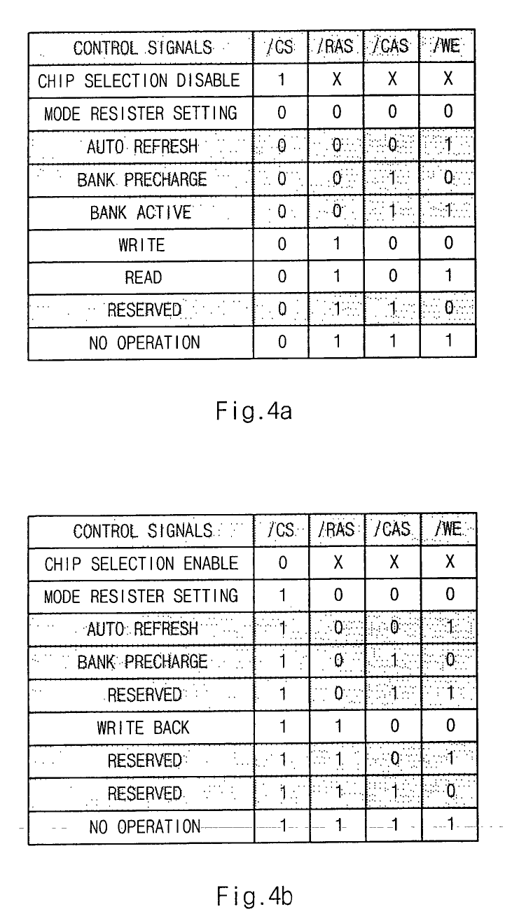

FIGS. 4a and 4b are examples illustrating a main operation command table and a preliminary operation command table according to the present invention. In these tables, CS represents a chip selecting signal, RAS row address strobe signal, CAS column address strobe signal, and WE write enable signal. The main operation command table defines an operation when a chip selecting signal is enabled while the preliminary operation command table defines an operation when a chip selecting signal is disabled.

In case of mode resister setting, the preliminary operation command table can be defined to have every memory devices in the same memory subsystem perform same mode resister setting when the memory device having enabled chip selecting signals performs a mode resister setting. For example, when a memory subsystem has four memory devices, the conventional memory subsystem requires 4 timing slots for mode resistor setting of all memory devices while the memory subsystem of the present invention completes mode resistor setting of all memory devices during one timing slot.

In case of auto-refresh, a memory device having disabled chip selecting signals can perform auto-refresh when its bank is at a precharge condition. The preliminary operation command table can be defined to have memory devices having disabled chip selecting signals and having precharged banks perform an auto refresh when the memory device having enabled chip selecting signals performs an auto refresh.

In case of bank precharge, when a memory device of which the relevant bank are at an active condition and tRAS is beyond the minimum value, or of which the relevant bank is already precharged can perform a bank precharge. The preliminary operation command table can be defined to have memory devices having disabled chip selecting signals and having the precharged bank (or having tRAS is beyond the minimum value) perform a bank precharge when the memory device having enabled chip selecting signals performs a bank precharge.

In case of write, while a memory device having enabled chip selecting signals performs a write, other memory devices can write back input data stored in their buffers. The preliminary operation command table can be defined to have every memory having devices in the same memory subsystem perform a write back when the memory device having enabled chip selecting signals performs a write operation.

In this embodiment in FIGS. 4a and 4b, the operation is not defined when the memory device having enabled chip selecting signals performs a read operation and a bank active operation.

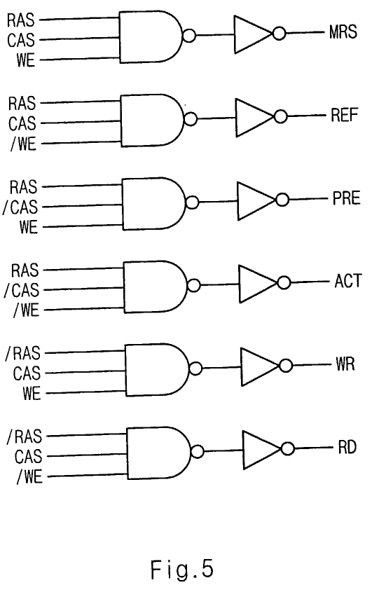

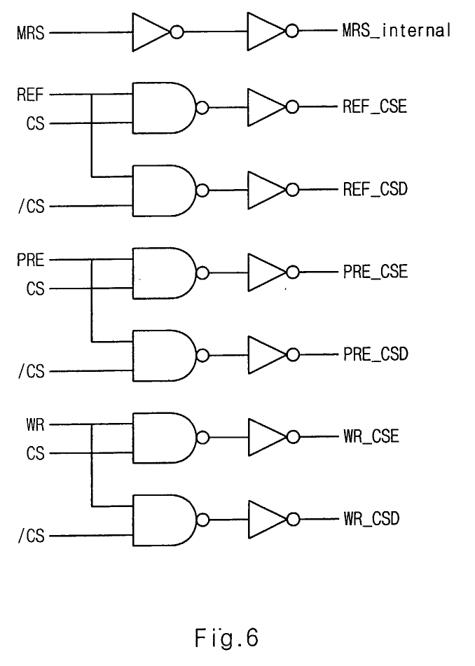

FIGS. 5 through 7 are diagrams illustrating structural examples of a logic circuit unit 24 according to the main operation command table and the preliminary operation command table of FIGS. 4a and 4b. Hereinafter, the operation of the logic circuit unit 24 is now explained, referring to FIGS. 5 through 7. First, as shown in FIG. 5, the logic circuit unit 24 decodes a inputted RAS signal, a CAS signal, a mode resistor set MRS signal combined with WE signals, an auto-refresh signal REF, a bank precharge signal PRE, a bank active signal ACT, a write signal WR, and a read signal RD. As shown in FIG. 6, the logic circuit unit 24 identifies whether a chip selecting signal is inputted. When the MRS is applied, a command decoder outputs a mode resistor setting command MRS_internal irregardless of input condition of chip selecting signals. When the REF, the PRE and the WR are applied, the operation is changed according to chip selection. As a result, the command decoder decodes REF_CSE, REF_CSD, PRE_CSE, PRE_CSD, WR_CSE AND WR_CSD according to chip selection.

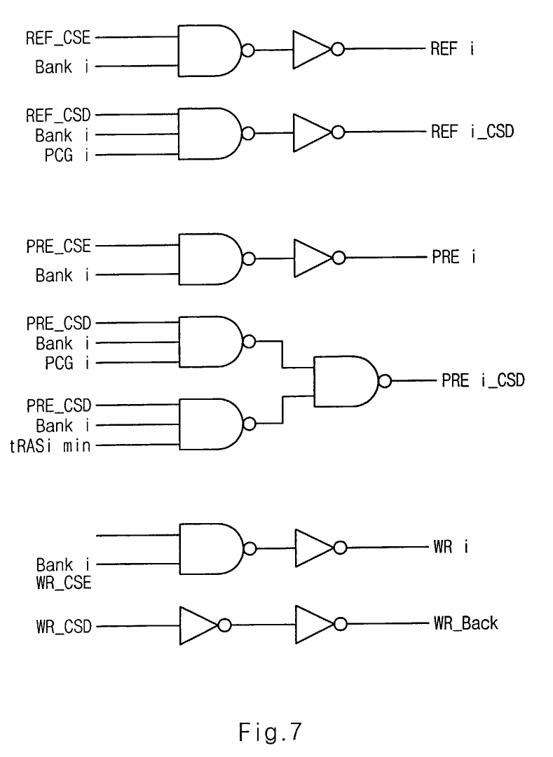

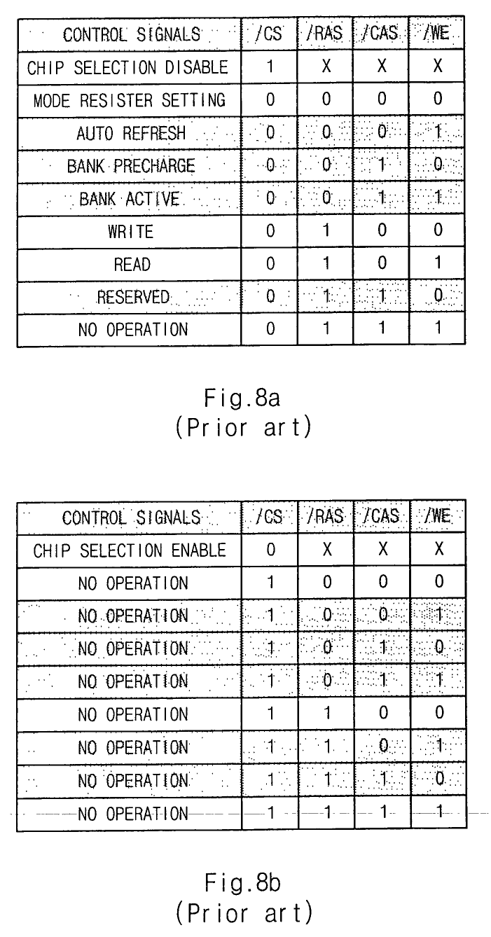

As shown in FIG. 7, when the control signal combination is decoded into refresh and chip selection REF_CSE, the logic circuit unit 24 enables the memory device 20 to refresh its relevant bank according to REF_CSE and its relevant signal Bank I. When the control signal combination is decoded into refresh and chip non-selection REF_CSD, the logic circuit unit 24 combines REF_CSD and Bank I. Here, the memory devices 30 and 40 may refresh their relevant bank only when they receive a signal PCG i which identifies whether the relevant bank is at a precharge condition. When the control signal combination is decoded into bank precharge and chip selection PRE_CSE, the logic circuit unit 24 enables the memory device 20 to precharge its relevant bank according to PRE_CSE and Bank I. When the control signal combination is decoded into bank precharge and chip non-selection REF_CSD, the logic circuit unit 24 combines the control signal REF_CSC with Bank I. The memory devices 30 and 40 precharge their relevant banks only when they receive the signal PCG I, which identifies whether the relevant bank is at a precharge condition, or the signal tRASi,min which identifies whether time of sustaining RAS activated state of the relevant bank satisfies the minimum value. When the control signal combination is decoded into write and chip selection WR_CSE, the logic circuit unit 24 enables the memory device 20 to write data in its relevant bank according to WR_CSE and Bank I. When the control signal combination is decoded into write and chip non-selection WR_CSD, the logic circuit unit 24 enables the memory device to write bank according to WR_CSD.

However, the preliminary command table corresponding to the bank active signal and the read signal of the main operation command table is left preliminarily. Like the conventional memory subsystem, a logic circuit thereof is not illustrated because a decoder of the memory device having enabled chip selecting signals only performs a relevant operation.

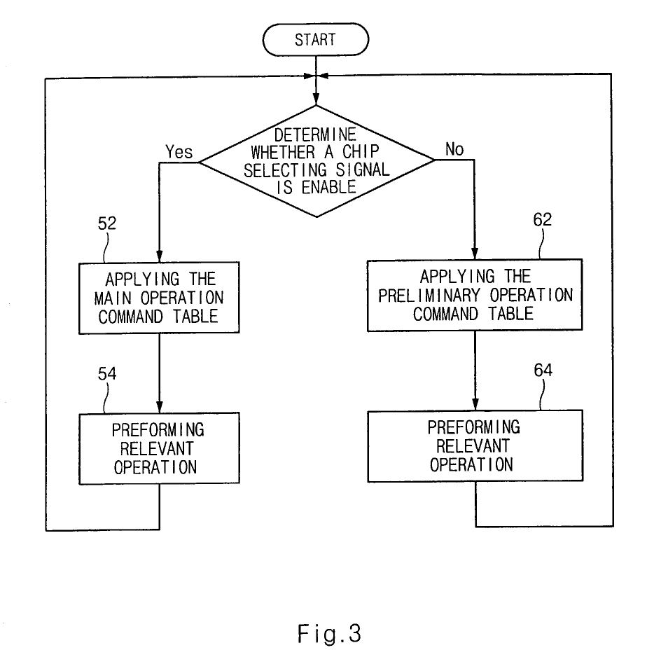

FIG. 3 is a flow chart illustrating a memory control method according to a preferred embodiment of the present invention.

First, the memory device 20 determines whether a chip selecting signal CS is enabled (the first step). As a determination result of the first step, if the CS is enabled, the logic circuit unit 24 of the memory device 10 decodes the combination of control signals COMMANDs applied to the memory device 10 by applying the main operation command table 26 (the second step). Here, the main operation command table 26 may be the same or similar to command tables of the common memory device. Next, the memory device 10 performs a relevant operation according to a decoding result of the second step, and then returns to the first step (the third step).

As a determination result of the first step, if a chip selecting signal CS is disabled, the logic circuit unit 24 decodes the combination of control signals COMMANDs applied to the memory device 20 by applying the preliminary operation command table 27 (the fourth step). Here, the applied COMMAND generally corresponds to the operation defined by the main operation command table 26 of the memory device having enabled CSs. More desirably, the chip selecting signal CS may be a signal to control a memory device having disabled CSs. It is also desirable that the operation of the memory device defined by the preliminary operation command table 27 has no effect on other devices of another memory subsystem.

The present invention can be applied to all kinds of memory devices such as dynamic RAM, static RAM, flash RAM and ROM.

It should be understood that the present invention is not limited to the particular forms disclosed. Rather, the invention covers all modifications, equivalents, and alternatives falling within the spirit and scope of the invention as defined in the appended claims.

As discussed earlier, the memory device of the present invention can perform a predetermined operation on the control of other memory devices. As a result, bandwidths of a control bus are improved, and command tracking of the memory controller is also simplified, thereby resulting in simplifying the design of the memory controller.

What is claimed is:

1. A memory device for receiving chip selecting signals and a plurality of control signals from a memory controller, comprising:
a chip selecting determiner for deciding whether the chip selecting signals;
a main operation command table for defining a predetermined operation corresponding to combination of the control signals when the chip selecting signals are enabled;
a preliminary operation command table for defining a predetermined operation corresponding to combination of the control signals when the chip selecting signals are disabled; and
a logic circuit unit for decoding the combination of the control signals into a predetermined operation, based on the main operation command table or the preliminary operation command table according to enable conditions of the chip selecting signals from the chip selecting determiner.

2. The memory device according to claim 1, wherein the predetermined operation defined by the preliminary operation command table has no effect on other devices forming a memory subsystem to the memory device belongs.

3. The memory device according to claims 1 or 2,
wherein the preliminary command table defines a control signal corresponding to write operation of the main operation command table as write back operation; and
wherein the logic circuit unit in a memory device having disabled chip selecting signals decodes the combination of control signals corresponding to write operation into another memory device having enabled chip selecting signals so that the memory device of the logic circuit may perform write back operation.

4. The memory device according to claims 1 or 2,
wherein the preliminary operation command table defines control signals corresponding to auto-refresh operation of the main operation command table as auto-refresh operation;
wherein the logic circuit unit in a memory device having disabled chip selecting signals decodes the combination of control signals corresponding to auto-refresh operation into another memory device having enabled chip selecting signals so that the memory device of the logic circuit may perform auto-refresh-operation if a relevant bank of the memory device is at precharge condition.

5. The memory device according to claims 1 or 2,
wherein the preliminary operation command table defines control signals corresponding to bank precharge operation of the main command table;
wherein the logic circuit unit in a memory device having disabled chip selecting signals decodes the combination of control signals corresponding to bank precharge operation into another memory device having enabled chip selecting signals so that the memory device of the logic circuit may perform bank precharge operation if a relevant bank of the memory device is at a precharge condition or at a minimum value of tRAS.

6. A memory subsystem comprising a plurality of memory devices for receiving a plurality of common control signals from a memory controller and the memory controller and each chip selecting signal,
wherein the memory device comprises a chip selecting determiner for deciding whether the chip selecting signal is selected; a main operation command table for defining a predetermined operation corresponding to combination of the control signals for memory device having enabled chip selecting signals; a preliminary operation command table for defining a predetermined operation corresponding to combination of the control signals for memory device having disabled chip selecting signals; and a logic circuit unit for decoding the combination of the control signals into a predetermined operation, based on the main operation command table or the preliminary operation command table according to enable conditions of the chip selecting signals from the chip selecting determiner, and
wherein the memory device having the enabled chip selecting signals applies the main operation command table while the memory device having disabled chip selecting signals applies the preliminary operation command table, decodes the combination of the control signals, and then performs a relevant operation.

7. The memory subsystem according to claim 6, wherein the predetermined operation defined by the preliminary operation command table has no effect on other devices forming the memory subsystem to which the memory device belongs.

8. The memory subsystem according to claims 6 or 7,
wherein the preliminary operation command table defines a first control signal combination corresponding to write operation of the main operation command table as write back operation; and
wherein according to input condition of the first control signal combination, a memory device having enabled chip selecting signals signal performs write operation while a memory device having disabled chip selecting signals performs write back operation.

9. The memory subsystem according to claims 6 or 7,
wherein the preliminary operation command table defines a second control signal combination corresponding to auto-refresh operation of the main operation command table as auto-refresh operation; and
wherein according to input condition of the second control signal combination, a memory device having enabled chip selecting signals signal performs auto-refresh operation while a memory device having disabled chip selecting signals performs auto-refresh operation if its relevant bank is at a precharge condition.

10. The memory subsystem according to claims 6 or 7,
wherein the preliminary operation command table defines a third control signal combination corresponding to bank precharge operation of the main operation command table as bank precharge operation;
wherein according to input condition of the third control signal combination, a memory device having enabled chip selecting signals performs bank precharge operation while a memory device having disabled chip selecting signals performs bank precharge operation if a relevant bank is at a precharge condition or at a minimum value of tRAS.

11. A method of controlling a memory device for receiving chip selecting signals and a plurality of control signals from a memory controller, comprising:
the first step wherein the memory device determines whether the chip selecting signals are applied;
the second step wherein when the chip selecting signal is enabled as a determination result of the first step, the logic circuit unit of the memory device decodes combination of the control signals applied to the memory device by using a main operation command table;
the third step wherein the memory device performs a relevant operation according to a decoding result of the second step and then returns to the first step;
the fourth step wherein when the chip selecting signal is disabled as a determination result of the first step, the logic circuit unit of the memory device decodes combination of the control signals applied to the memory device by using a preliminary operation command table; and
the fifth step wherein the memory device performs a relevant operation according to a decoding result of the fourth step and then returns to the first step.

12. The method according to claim 11, wherein the predetermined operation defined by the preliminary operation command table has no effect on other devices forming a memory subsystem to which the memory device belongs.
